(19) United States
(12) Patent Application Publication
(10) Pub. No.: US 2009/0045973 A1
(43) Pub. Date: Feb. 19, 2009

(54) COMMUNICATIONS OF DOWNHOLE TOOLS FROM DIFFERENT SERVICE PROVIDERS

(76) Inventors: Paul F. Rodney, Spring, TX (US); Clive D. Menezes, Houston, TX (US)

Correspondence Address: SCHWEGMAN, LUNDBERG & WOESSNER, P.A., P.O. BOX 2938, MINNEAPOLIS, MN, 55402, US

(21) Appl. No.: 11/839,913

(22) Filed: Aug. 16, 2007

(51) Int. Cl. G01V 3/00

(52) U.S. Cl. 340/853.2

(57) ABSTRACT

In some embodiments, an apparatus comprises a tubular for downhole operations. The tubular comprises a bottomhole assembly. The bottomhole assembly comprises a first downhole tool having a first sensor that is to generate a first data, wherein a first entity is at least one of a controller or an owner of the first downhole tool. The bottomhole assembly comprises a second downhole tool having a second sensor that is to generate a second data, wherein a second entity is at least one of a controller or an owner of the second downhole tool. The first data and the second data are to be coded in a common format. The bottomhole assembly also comprises a processor to execute instructions to receive and process the first data and the second data.

### TECHNICAL FIELD

The application relates generally to hydrocarbon recovery. In particular, the application relates to communications of downhole tools from different service providers for hydrocarbon recovery.

### BACKGROUND

During drilling operations for extraction of hydrocarbons, various downhole measurements (such as formation evaluation measurements, measurements related to the borehole, etc.) can be made. Examples of the various downhole measurements include resistivity measurements, pressure measurements, caliper measurements for borehole size, directional measurements, etc. Various downhole tools include sensors for these downhole measurements.

### BRIEF DESCRIPTION OF THE DRAWINGS

Embodiments of the invention may be best understood by referring to the following description and accompanying drawings which illustrate such embodiments. In the drawings:

FIG. 1 illustrates a drilling well during Measurement While Drilling (MWD)/Logging While Drilling (LWD) operations that includes multiple downhole tools, according to some embodiments.

FIG. 2 illustrates a bottomhole assembly having multiple downhole tools from more than one service provider, according to some embodiments.

FIG. 3 illustrates a system diagram of the entities and related data for a drilling operation that includes multiple downhole tools, according to some embodiments.

FIG. 4 illustrates a file structure for storage of data from multiple downhole tools, according to some embodiments.

FIG. 5 illustrates a flow diagram for communications and processing of data from downhole tools of different service providers, according to some embodiments.

FIG. 6 illustrates a flow diagram for communications of control data downhole to downhole tools of different service providers, according to some embodiments.

FIG. 7 illustrates a computer that executes software for performing operations related to communications of downhole tools from different downhole service providers, according to some embodiments.

### DETAILED DESCRIPTION

Methods, apparatus and systems for communications of downhole tools from different service providers for hydrocarbon recovery are described. In the following description, numerous specific details are set forth. However, it is understood that embodiments of the invention may be practiced without these specific details. In other instances, well-known circuits, structures and techniques have not been shown in detail in order not to obscure the understanding of this description. Some embodiments may be used in Measurement While Drilling (MWD), Logging While Drilling (LWD) and wireline operations.

Some embodiments provide a common communications protocol to be used by downhole tools of a drill string that are from different service providers. In some embodiments, the data transmitted among the downhole tools and surface components is coded according to a common format. In conventional communications, different service providers of the downhole tools may use different communications protocols, different data formats, etc. Thus, an operator of a wellsite could not intermix downhole tools from different service providers in a same bottomhole assembly. As further described below, some embodiments allow for a bottomhole assembly that may comprise various downhole tools from any number of different service providers.

The downhole tools from the different service providers may use a communications interface that has the same electrical and mechanical interfaces. In some embodiments, the downhole tools include wired drill pipe for communications among the various sections of drill pipe. Some embodiments provide a common communications protocol to be used for communications among the different downhole tools, other communication components along the drill string, surface communication components, etc. A common communications protocol enables downhole tools from different service providers to transmit collected data to a surface computer for analysis of such data. Similar, a common communications protocol enables downhole tools from different service providers to receive data (such as control information) from a surface computer. Further, a commonly coded data format across different service providers enables easier analysis of such data. In particular, an entity independent of the service providers may analyze the data collected by different service providers, without requiring the decoding of the data that is dependent on the service provider whose downhole tool collected the data.

To illustrate, a bottomhole assembly may comprise a first downhole tool for electromagnetic resistivity measurements that is provided by service provider A. The same bottomhole assembly may comprise a second downhole tool for seismic while drilling operations that is provided by service provider B. The same bottomhole assembly may comprise a third downhole tool magnetic resonance imaging logging that is provided by service provider C. Accordingly, a same bottomhole assembly may comprise any number of downhole tools that may be provided by any number of service providers.

A surface computer (located near the rig surface, remote location (such as the back office), etc.) may receive and transmit data to downhole tools from different service providers. As further described below, the surface processing may be organized so that data received from downhole are recorded and plotted near or at real time. The logs plotted would include data provided by various service providers as processed downhole. Further processing, such as borehole, standoff, thin bed, invaded zone, photoelectric effect (for nuclear sensors) and background corrections could be applied by the service providers by accessing their data from a common data pool. In some embodiments, data access is restricted. Accordingly, a service provider may only access its own data. Alternatively or in addition, the entities operating the wellsite may specify what and how corrections are to be applied to the data logs. In some embodiments, one entity, which may or may not different from one of the service providers, may access the common data pool and provide a combined log analysis.

Thus, some embodiments allow the use of tools from different service providers, while the data therefrom appears to be from one such provider. In some embodiments, an operating entity may engage a coordinating entity to plan and drill the well and to provide data as required by the operating entity. Moreover, a same coordinating entity may also arrange for the casing and completion of the well. The coordinating entity may select the group of service providers to provide the downhole services (with or without approval of the operating entity). Also, the coordinating entity may similarly select the driller, the provider(s) of the borehole telemetry and, where needed, a real time link to facilities selected by the operating entity.

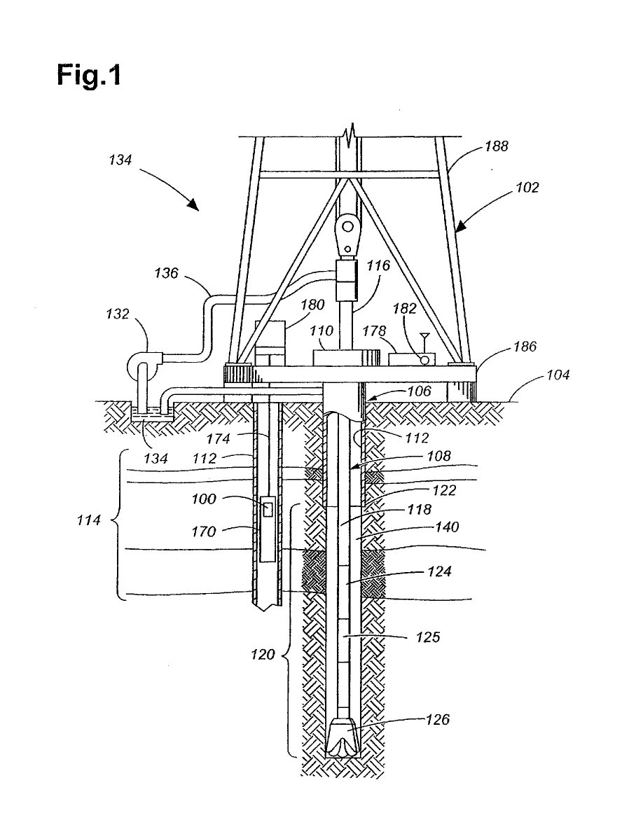

A system operating environment, according to some embodiments, is now described. FIG. 1 illustrates a drilling well during MWD/LWD operations that includes multiple downhole tools, according to some embodiments. It can be seen how a system 164 may also form a portion of a drilling rig 102 located at a surface 104 of a well 106. The drilling rig 102 may provide support for a drill string 108. The drill string 108 may operate to penetrate a rotary table 110 for drilling a borehole 112 through subsurface formations 114. The drill string 108 may include a Kelly 116, a drill pipe 118, and a bottomhole assembly 120, perhaps located at the lower portion of the drill pipe 118.

The bottomhole assembly 120 may include drill collars 122, a downhole tool 124, and a drill bit 126. The drill bit 126 may operate to create a borehole 112 by penetrating the surface 104 and subsurface formations 114. The downhole tool 124 may comprise any of a number of different types of tools including MWD (measurement while drilling) tools, LWD (logging while drilling) tools, and others.

In some embodiments, the drill pipe 118 is a wired drill pipe for communications between the surface of the Earth to the downhole tool 124 and the downhole tool 125. The drill pipe 118 can include one or more communications buses for wired communication. For example, the communications buses may be coaxial cable, twisted-pair wiring, optical cabling, etc. The communications protocol on the communications line may be at any of the different layers of the Internet protocol suite. For example, the communications protocol may be the application layer, transport layer, network layer or link layer. For example, in some embodiments, the communications protocol is based on Ethernet (Institute of Electrical and Electronics Engineers (IEEE) 802.3). As further described below, in some embodiments, the downhole tool 124 may be controlled, leased from, owned by, partially owned by, etc. a first entity (such as Oil Services Company A). The downhole tool 125 may be controlled, leased from, owned by, partially owned by, etc. a second entity (such as Oil Services Company B). In some embodiments, the drill pipe 118 may be controlled, leased from, owned by, partially owned by, etc. a third entity (such as Oil Services Company C). In some embodiments, the first entity, the second entity and the third entity are independent of each other. In some embodiments, the drill pipe 118 may be controlled, leased from, owned by, partially owned by, etc. by the first entity and/or the second entity. As further described below, in some embodiments, the downhole tool 124 and the downhole tool 125 both use the communications line in the drill pipe 118 for communication with and from the surface of the Earth.

During drilling operations, the drill string 108 (perhaps including the Kelly 116, the drill pipe 118, and the bottomhole assembly 120) may be rotated by the rotary table 110. In addition to, or alternatively, the bottomhole assembly 120 may also be rotated by a motor (e.g., a mud motor) that is located downhole. The drill collars 122 may be used to add weight to the drill bit 126. The drill collars 122 also may stiffen the bottomhole assembly 120 to allow the bottom hole assembly 120 to transfer the added weight to the drill bit 126, and in turn, assist the drill bit 126 in penetrating the surface 104 and subsurface formations 114.

During drilling operations, a mud pump 132 may pump drilling fluid (sometimes known by those of skill in the art as “drilling mud”) from a mud pit 134 through a hose 136 into the drill pipe 118 and down to the drill bit 126. The drilling fluid can flow out from the drill bit 126 and be returned to the surface 104 through an annular area 140 between the drill pipe 118 and the sides of the borehole 112. The drilling fluid may then be returned to the mud pit 134, where such fluid is filtered. In some embodiments, the drilling fluid can be used to cool the drill bit 126, as well as to provide lubrication for the drill bit 126 during drilling operations. Additionally, the drilling fluid may be used to remove subsurface formation 114 cuttings created by operating the drill bit 126.

The different components of FIG. 1 may all be characterized as “modules” herein. Such modules may include hardware circuitry, and/or a processor and/or memory circuits, software program modules and objects, and/or firmware, and combinations thereof, as desired by the architect of the systems shown in FIG. 1, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

It should also be understood that the apparatus and systems of various embodiments can be used in applications other than for drilling and logging operations, and thus, various embodiments are not to be so limited. The illustrations of the systems of FIG. 1 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, personal computers, workstations, vehicles, and conducting cables for a variety of electrical devices, among others. Some embodiments include a number of methods.

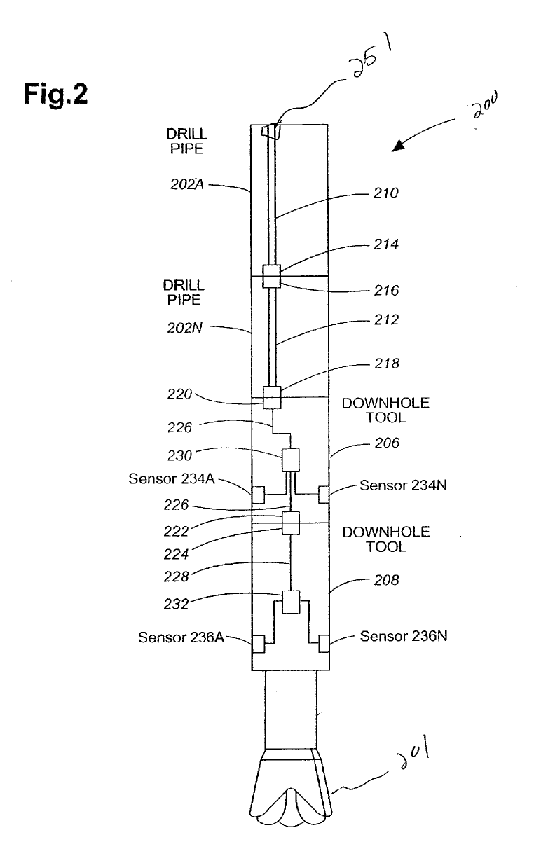

FIG. 2 illustrates a drill string that includes a bottomhole assembly having downhole tools from more than one service provider, according to some embodiments. In particular, FIG. 2 illustrates a drill string 200 wherein a bottomhole assembly may include different downhole tools from different service providers. Accordingly, an operating entity may form a bottomhole assembly that includes a first downhole tool for one service from a first service provider, a second downhole tool for a second service from a second service provider, etc.

The drill string 200 includes a drill bit 201, a downhole tool 206, a downhole tool 208 and drill pipe sections 202A-202N. The downhole tools 206-208 may be part of a bottomhole assembly. In some embodiments, the downhole tool 206, the downhole tool 208 and the drill pipe sections 202A-202N communicate through a wired drill pipe configuration.

While illustrated with two downhole tools, the bottomhole assembly may include any number of such tools. The types of downhole tools may vary in terms of type of service, ownership, control, etc. Different entities (such as different downhole service providers) may own or control the different downhole tools that are part of a bottomhole assembly. Thus, the downhole tools in a bottomhole assembly may have different owners or controllers. For example, four different types of services from four different tools may be provided by four different service providers. In another example, five different services from three different tools may be provided by two different service providers. As further described below, the different tools use a common communications protocol for data communications. In some embodiments, the data communicated among the downhole tools and a surface component is coded in accordance with a common data format.

The downhole tool 208 comprises a host component 232, sensors 236A-236N, a communications bus 228 and an interface 224. The downhole tool 206 comprises a host component 230, sensors 234A-234N, a communications bus 226, an interface 222 and an interface 220. The host component 230/232 may include processor(s), various machine-readable media, etc.

In some embodiments, the communications bus 226/228 may be a communications bus to which the host component 230/232, the sensors 234/236 and the interface 220/222/224 are communicatively coupled. In some embodiments, the host component 230 and the host component 232 may provide control of the sensors 234 and the sensors 236, respectively. Also, the host component 230 and the host component 232 may receive and store data collected by the sensors 234 and the sensors 236, respectively. The sensors 234/236 may measure various downhole characteristics (including different formation evaluation characteristics, borehole characteristics, etc.). For example, the sensors 234/236 may include sensors for drilling vibration, pressure while drilling, at-bit inclination, compensated thermal neutron, weight on bit, directional module, battery module, resistivity (such as electromagnetic, gamma ray, neutron, acoustic etc.), acoustic caliper sensors, azimuthal data, Formation Testing While Drilling (FTWD), magnetic resonance imaging logging, seismic while drilling, etc.

The host component 230 and the host component 232 may store the data from the sensors 234 and the sensors 236, respectively, for subsequent transmission to the surface for processing and analysis thereof. The host component 230 and the host component 232 may also receive data from the surface (such as control information). The host component 230 and the host component 232 may then control the sensors 234 and the sensors 236, respectively. In some embodiments, the downhole tools do not include a host component. Accordingly, control and data collection may be performed by a computer at the surface (independent of a local host component).

The drill string 200 includes drill pipe sections 202. The drill pipe section 202A includes an interface 251, an interface 214 and a communications bus 210. The communications bus 210 transmits data between the interface 251 and the interface 214. The drill pipe section 202N includes an interface 216, an interface 218 and a communications bus 212. The communications bus 212 transmits data between the interface 216 and the interface 218.

In some embodiments, the interfaces between the downhole tools and the drill pipe sections are configured to communicate as wired drill pipe. Thus, the interfaces include a same electrical and mechanical interface. Thus, the interface 222 may communicate with the interface 226. The interface 220 may communicate with the interface 218. The interface 216 may communicate with the interface 214. These series of drill pipe sections may continue up the drill string to the surface.

While described relative to wired communications, some embodiments may use a common protocol across downhole tools from multiple service providers using other types of communications. For example, some embodiments may be used for wireless communications, mud pulse communications, etc. Moreover, while described such that the common protocol is for surface to downhole communications and vice versa, embodiments are not so limited. Some embodiments may use the common protocol for communications among components of the downhole tools. For example, one of the host components may be designated as a central repository of data. Accordingly, the different downhole tools may communicate with this host component for storage of data therein, to receive control information, etc. This particular host component may or may not be operated by an entity that is independent of any of the service providers. In some embodiments, a separate host component within the bottomhole assembly (but separate from the downhole tools for the particular service providers) may collect the data from the different downhole tools, control the different downhole tools, etc.

Any number of different common communications protocols may be used for communications among the different downhole tools and the surface. For example, the common communications protocol may include requirements on the size of packet of data, the size and content of the header, payload, etc. In some embodiments, the requirements may include whether there is data authentication, encryption, error detection, etc. The requirements may also include the type of data authentication, encryption, error detection, etc. In some embodiments, the common communications protocol may include protocols at the different layers of the Transmission Control Protocol/Internet Protocol (TCP/IP) model or the Open Systems Interconnection (OSI) model. For example, the common communications protocol may include a protocol at the data link layer, network layer, transport layer, application layer, etc. For example, the common communications protocol may include a data link layer protocol (such as Ethernet (Institute of Electrical and Electronics Engineers (IEEE) 802.3), Asynchronous Transfer Mode (ATM), Frame Relay, Layer 2 Tunneling Protocol (L2TP), etc.). The common communications protocol may include a network layer protocol (such as Internet Protocol (IP) (e.g., IP version 4, IP version 6, etc.), IP security (IPsec), etc.). The common communications protocol may include a transport layer protocol (such as Transmission Control Protocol (TCP), User Datagram Protocol (UDP), etc.). The common communications protocol may include an application layer protocol (e.g., Dynamic Host Configuration Protocol (DHCP), File Transfer Protocol (FTP), etc.). Accordingly, because of the common communications protocol, the communications buses of the downhole tools from different service providers may be shared among each other.

The data may be coded into any number of formats. For example, the data may be stored in the payload of a packet of data in a given format. In some embodiments, the format of the payload may be dependent on the type of data stored therein. To illustrate, the format of data for resistivity measurements may vary from the format of data for measurement for borehole size. For example, in a payload of a packet, the format of data for resistivity measurements may comprise one or more entries, wherein an entry may comprise a time stamp, a resistivity measurement, a depth measurement, etc. Therefore, if the data is coded according to a common format, the format of the payload is consistent for data produced by different service providers. Thus, the decoding of data from the payload of packets remains the same for different service providers. If an independent entity performs decoding and analysis of such data, their operations may be consistent across downhole tools from different service providers.

In some embodiments, the components (including the host components and the sensors in the downhole tool) include instructions to detect computer viruses, tracking or monitoring software, etc. Such detection may alleviate concerns that one downhole service provider could load such software into the downhole tool of a different downhole service provider because of the sharing of communications buses. Such detection may be periodically executed, executed on new data received, etc. If detection occurs, the downhole tool may issue an alarm that is transmitted to the surface, cease operation of the downhole tool, cease operation of the infected component in the downhole tool, etc.

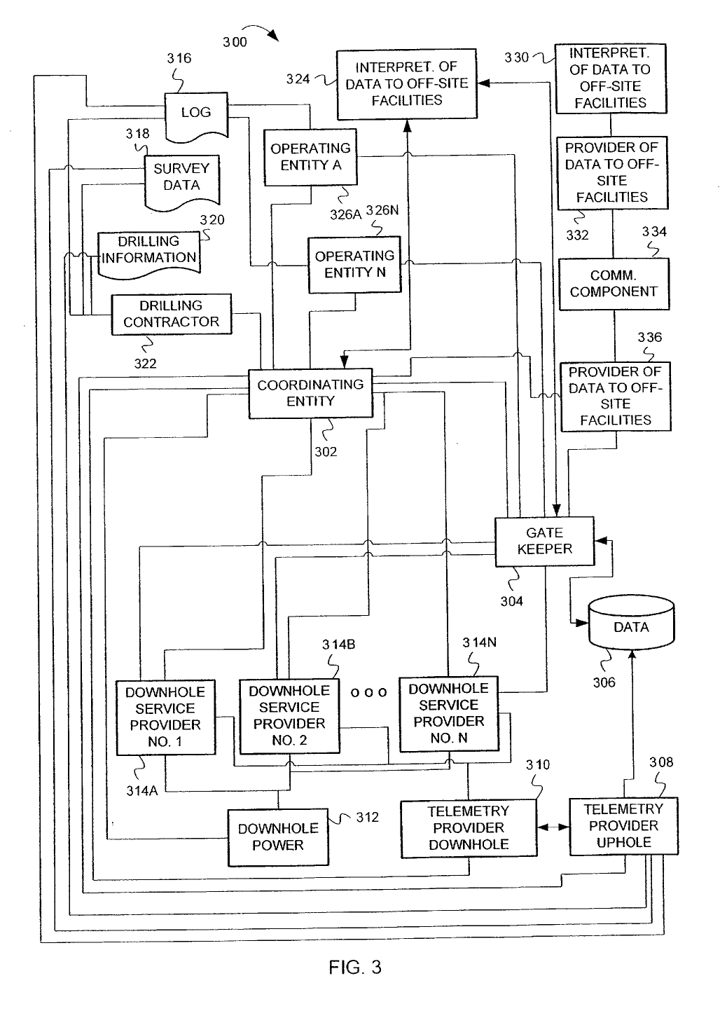

FIG. 3 illustrates a system diagram of the entities and related data for a drilling operation that includes multiple downhole tools, according to some embodiments. FIG. 3 illustrates a system 300 that illustrates the different components/entities for data communications in a wellsite operating environment using a common communications protocol for downhole tools from different service providers.

The system 300 includes a coordinating entity 302. The coordinating entity 302 controls the other components/entities in the system 300. The coordinating entity 302 may or may not be independent of other entities in the system 300. For example, in some embodiments, the coordinating entity 302 is one of the operating entities, one of the downhole service providers, telemetry providers, etc.

The system 300 also includes operating entities (A-N) 326A-326N. The operating entities 326 are entities that operate the wellsite operations (e.g., planning, drilling, casing, completion, etc.). One or more operating entities 326 may operate a given wellsite. As shown, the operating entities 326 are coupled to the coordinating entity 302. The operating entities 326 engage the coordinating entity 302 to control the wellsite operations. The coordinating entity 302 may select the group of service providers to provide different downhole services (with or without the approval of the operating entities 326). The coordinating entity 302 may also select the driller, the provider(s) for borehole telemetry, and, where needed, the entity that provides a real time link to facilities selected by the operating entities 326.

The system 300 also includes a drilling contractor 322 to perform the drilling operation. The coordinating entity 302 is coupled to the drilling contractor 322. The coordinating entity 302 may select and control the drilling contractor 322. The drilling contractor 322 is also coupled to drilling information 320, survey data 318 and log data 316. The drilling information 320 includes data for the planning of the drilling as well as data produced during the drilling operation. The drilling contractor 322 may access and update the drilling information 320.

The system 300 also includes downhole service providers 314A-314N. The downhole service providers 314 are coupled to the coordinating entity 302. The downhole service providers 314 may provide the different downhole tools that are selected by the coordinating entity 302 to be used in the bottomhole assembly of the drill string.

The system 300 also includes downhole power 312. The downhole power 312 may be different types of power sources (e.g., a battery, a mud-driven power source, etc.). The downhole power 312 may be anywhere along the drill string (e.g. a component in the bottomhole assembly, which may or may not be part of one of the other downhole tools). The coordinating entity 302 and the downhole service providers 314 are coupled to the downhole power 312. In some embodiments, the downhole power 312 is shared among the downhole tools from the different downhole service providers 314. The coordinating entity 302 may control the distribution of power to these downhole tools. In some embodiments, each downhole tool may includes it own power source.

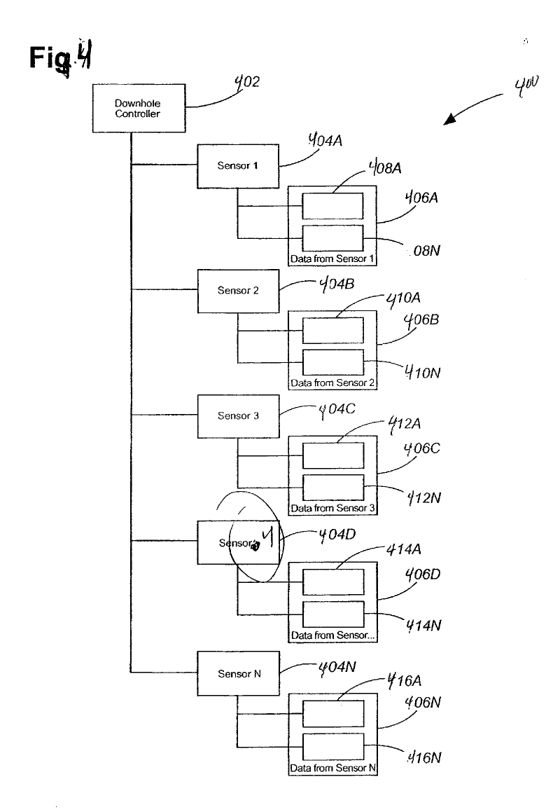

The system 300 includes a telemetry provider downhole 310 and a telemetry provider uphole 308. As described above, the communications from downhole to surface and vice versa may comprise wired drill pipe, wireless communications, mud pulse, etc. In some embodiments, the telemetry provider downhole and uphole 310/308 control these communications. The telemetry provider downhole 310 is coupled to the telemetry provider uphole 308. The telemetry provider downhole 310 and the telemetry provider uphole 308 are coupled to the coordinating entity 302. The coordinating entity 302 may control the selection of an entity to be the telemetry provider downhole 310 and the telemetry provider uphole 308. The telemetry provider downhole 310 and the telemetry provider uphole 308 may or may not be a same entity. In some embodiments, the telemetry provider downhole 310 and the telemetry provider uphole 308 may or may not be independent of the downhole service providers. The telemetry provider downhole 310 is coupled to downhole service providers 314. The telemetry provider uphole 308 is coupled to a database 306, the log 316, the survey data 318 and the drilling information 320. The log 316, the survey data 318 and the drilling information 320 are different types of data that may be stored in the database 306. The database 306 may be located somewhere at the surface (near the wellsite, remote location, etc.). Alternatively or in addition, the database 306 may be in a machine-readable medium downhole. The data in the database 306 may be separated based on which sensor in the bottomhole assembly provided the data. An example file structure for storage of data in the database 306 is illustrated in FIG. 4, which is described in more detail below. The log 316 represents the data from the different sensors in the different downhole tools.

The system 300 also includes a gatekeeper 304 that restricts access to the data stored in the database 306. For example, data from a downhole tool from service provider A may not be allowed access to data from a downhole tool from service provider B. The gatekeeper 304 may be software, firmware, hardware or a combination thereof that is located at a surface location. Alternatively or in addition, the gatekeeper 304 may be an individual (such as an operator) that reviews access to the data in the database 306. The gatekeeper 304 may or may not be independent of the coordinating entity 302 or operating entities 326. As shown, the gatekeeper 304 is coupled to the database 306, the downhole service providers 314, the coordinating entity 302, the operating entities 326, interpretator of data 324 and a provider of data to off-site facilities 336. Therefore, to access the data in the database 306, the entity attempting to access is required to have the requisite authority. For example, the coordinating entity 302 and the operating entities 326, the interpretator of data 324 and the provider of data to off-site facilities 336 may have access to any of the data, while a given downhole service provider 314 is only allowed accessed for the data collected by their particular downhole tools. In some embodiments, a given operating entity 326 may have limited access. For example, assume that multiple operating entities 326 are involved in the wellsite operations. A given operating entity 326 may have only have access to the data for those operations for which the operating entity 326 is involved.

Moreover, interpretator of data 324 and interpretator of data 330 may provide analysis (either manual and/or automated) that interprets the data received from downhole. The interpretator of data 324 and the interpretator of data 330 may be software, firmware, hardware or a combination thereof that is located at a surface location. Alternatively or in addition, the interpretator of data 324 and the interpretator of data 330 may be an individual (such as an operator) to provide such analysis. For example, the interpretator of data 324 and the interpretator of data 330 may include a processor unit to provide such analysis. In some embodiments, the interpretator of data 324 and the interpretator of data 330 (such as the processor unit) may issue a command to modify an operation. For example, the processor unit may issue a command to modify a downhole drilling parameter (such as direction, inclination, mud weight, etc.). In some embodiments, the interpretator of data 324 and the interpretator of data 330 may be one or more entities (that may or may not be independent of the downhole service providers 314, the coordinating entity 302 and the operating entities 326). The coordinating entity 302 or the operating entities 326 may determine access to the data in the database 306.

As shown, the provider of data 336 is coupled to a communications component 334, which is coupled to a provider of data 332. The provider of data 332 is coupled to an interpretator of data 330. The communications component 334 may be a component to provide wired or wireless communications. For example, the communications component 334 may be satellite communications, wherein data is uplinked to a satellite, which is subsequently downlinked to the provider of data 332. Alternatively or in addition, the communications component 334 may be a cellular communications for wireless communications between the provider of data 336 and the provider of data 332. Alternatively or in addition, the communications component 334 may be part of a wired communications (such as a component coupled to a wired network). For example, data may be communicated between the provider of data 336 and the provider of data 332 over the Internet. The interpretator of data 324 and the interpretator of data 330 may be controlled by a same or different entity. For example, the interpretator of data 324/330 may be controlled by one or more of the operating entities 326.

In some embodiments, the coordinating entity 302 may use various pricing models. The downhole service providers 314 may make bids to the coordinating entity 302 for certain operations. The coordinating entity 302 may then accept bids based on customer requirements. In some embodiments, the downhole service providers 314 are to be paid a fixed minimum plus a time fee, a data fee or a combination thereof based on actual usage of the service. Also, incentives may be provided, where appropriate, for performance ahead of schedule or below projected cost for the operation. Penalties may also be accessed, where appropriate, for performance behind schedule or over the projected cost for the operation. The coordinating entity 302 may bill the operating entities 326 for the services, including its own. For example, billable services of the coordinating entity 302 may include (1) coordination of the activities, (2) any specific services rendered by the coordinating entity 302 (such as management of data storage), (3) bonus for performance ahead of schedule of below projected cost and (4) rebate reduction for performance behind schedule or above projected cost.

FIG. 4 illustrates a file structure for storage of data from multiple downhole tools, according to some embodiments. A file structure 400 includes a first level that includes a directory for the downhole controller 402. Data from the different downhole tools are stored below this first level. The file structure 400 includes a second level below the first level. The second level includes multiple directories. The directories at the second level are associated with the different downhole sensors (which may be in the same or different downhole tools from the same or different service providers). A first directory 404A is for data from sensor one. A second directory 404B is for data from sensor two. A third directory 404C is for data from sensor three. A fourth directory 404D is for data from sensor four. A fifth directory 404N is for data from sensor five, etc.

The data for a sensor may be separated based on various criteria. For example, data from given time periods may be stored separately; each time data is received from downhole the data may be separately stored, etc. Sensor one data 406A includes data 408A, data 408N, etc. Sensor two data 406B includes data 410A, data 410N, etc. Sensor three data 406C includes data 412A, data 412N, etc. Sensor four data 406D includes data 414A, data 414N, etc. Sensor N data 406N includes data 416A, data 416N, etc. As described above, the data stored in the database 306 may be restricted. Accordingly, the file structure 400 may implement the restrictions. For example, the various directories may limit access to the data stored therein.

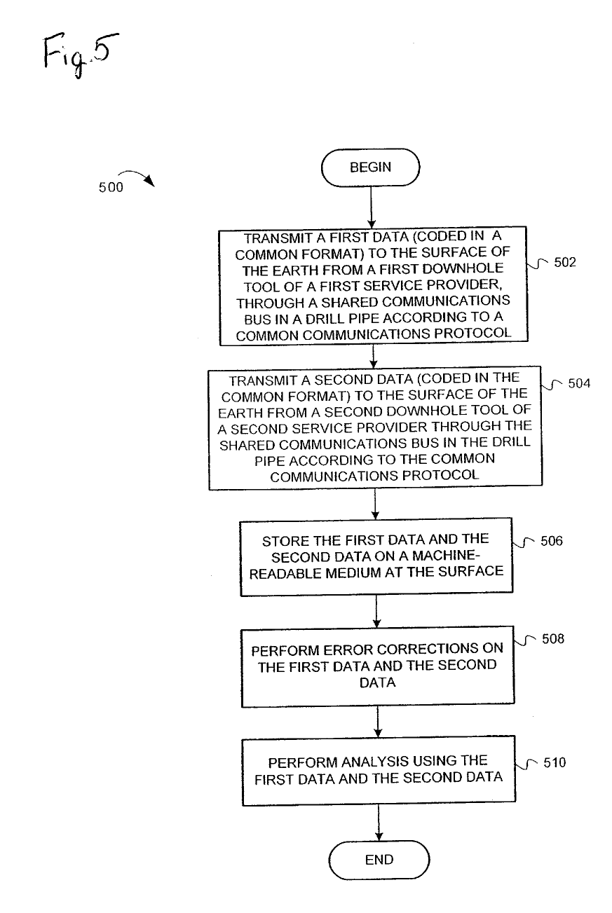

FIG. 5 illustrates a flow diagram for communications and processing of data from downhole tools of different service providers, according to some embodiments. The flow diagram 500 is described in reference to FIGS. 1-4.

At block 502, a first data (coded in a common format) is transmitted to the surface of the earth from a first downhole tool of a first service provider, through a shared communications bus in a drill pipe according to a common communications protocol. With reference to FIG. 2, the downhole tool 208 transmits the first data. As described above, the sensors 236 collect data regarding different downhole characteristics. The host component 232 may receive the data from the different sensors 236 and transmit the data to the surface. Alternatively or in addition, the sensors 236 may transmit the data directly to the surface (independent of the host component 232). The first data is transmitted according to a common communications protocol. In some embodiments, the first data is coded in a common format. Thus, the first data can be transmitted through the downhole tool 206 (which is from a different service provider) through the interfaces 222 and 224. In particular, because of the common communications protocol, the downhole tool from one service provider can use the communications bus of the downhole tool of a different service provider. This first data can also be transmitted through the communications bus of the different sections of drill pipe 202 to the surface of the Earth. The flow continues at block 504.

At block 504, a second data (coded in a common format) is transmitted to the surface of the earth from a second downhole tool of a second service provider, through the shared communications bus in a drill pipe according to the common communications protocol. With reference to FIG. 2, the downhole tool 206 transmits the second data. As described above, the sensors 234 collect data regarding different downhole characteristics. The host component 230 may receive the data from the different sensors 234 and transmit the data to the surface. Alternatively or in addition, the sensors 234 may transmit the data directly to the surface (independent of the host component 230). The second data is transmitted according to a common communications protocol. In some embodiments, the second data is coded in the common format (like the first data). This second data can be transmitted through the communications bus of the different sections of drill pipe 202 to the surface of the Earth. The flow continues at block 506.

At block 506, the first data and the second data are stored in a machine-readable medium at the surface. With reference to FIG. 3, the first data and the second data may be stored in the database 306. The database 306 may be representative of a machine-readable medium near the wellsite and/or a remote location. Also, the database 306 may be representative of one or more machine-readable media. For example, the data from downhole may be redundantly stored at different locations, stored at separate locations, etc. The flow continues at block 508.

At block 508, error corrections are performed on the first data and the second data. Error corrections may include borehole standoff, thin bed, invaded zone, photoelectric effect (for nuclear sensors), background corrections, etc. The error corrections may be performed by a person, software, or a combination thereof. In some embodiments, a downhole service provider (whose downhole tool collected the data) performs the error corrections on their own collected data (data from their downhole tool). One downhole service provider is not allowed access to the data of a different service provider. However, embodiments are not so limited. For example, the software for error correction of a given downhole service provider may be preferred by the operating entity. Therefore, the software from one downhole service provider may be used on the data from a different downhole service provider. In some embodiments, the data is not identified with the particular service provider, thereby easing concerns of allowing one downhole service provider access to the data of a different downhole service provider. In some embodiments, an entity that is independent of the downhole service providers may perform the error corrections. The types of corrections to apply may be determined by the particular downhole service provider, the operating entity, the coordinating entity, etc. In some embodiments, error corrections are not performed. The flow continues at block 510.

At block 510, analysis of the first data and the second data are performed. In some embodiments, an entity independent of the downhole service providers performs the analysis. Because of the common coded data format, an independent entity may perform the analysis. The analysis may include an interpretation of data from downhole tools from the different downhole service providers. The analysis may be performed near the wellsite, at a remote location, etc. Similar to the error correction, in some embodiments, the analysis may be performed by one of the downhole service providers. For example, if the software analysis from a given service provider is preferred by the operating entity or the coordinating entity, such software may be used. The operations of the flow diagram 500 are complete.

While described relative to storage and analysis of data at the surface of the Earth, embodiments are not so limited. For example, in some embodiments, one or more of the host components may store the data from different downhole tools. Moreover, some or all of the analysis may be performed downhole. In some embodiments, the storage and analysis may be in a component that is independent of the downhole tools of the downhole service providers.

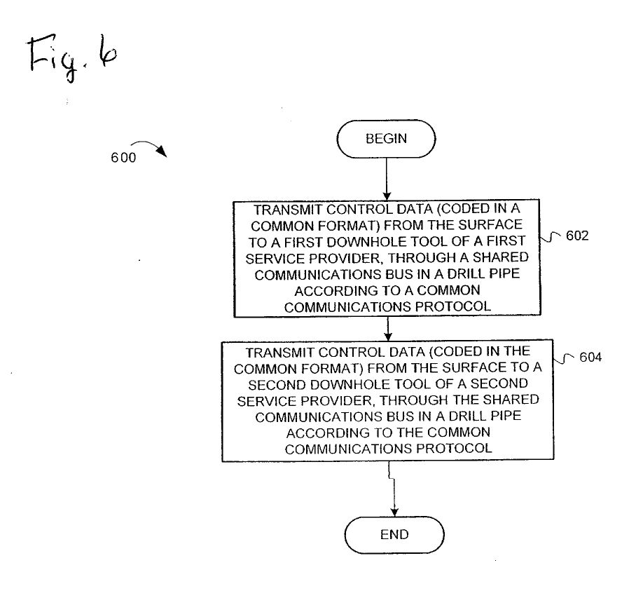

Example operations for communications from the surface to downhole are now described. FIG. 6 illustrates a flow diagram for communications of control data downhole to downhole tools of different service providers, according to some embodiments. The flow diagram 600 is described in reference to FIGS. 1-4.

At block 602, control data (coded in a common format) is transmitted from the surface to a first downhole tool of a first downhole service provider, through a shared communications bus in a drill pipe according to a common communications protocol. With reference to FIG. 2, a surface component may transmit the data along the communications buses in the different sections of drill pipe 202 and through communications buses of other downhole tools (similar to the communications from downhole to the surface). In particular the different communications buses across the different downhole tools and the drill pipe sections may be used because of the common communications protocol.

The control data may update a number of different parameters downhole. The control data may be updates to a downhole tool, a specific sensor in a downhole tool, etc. The control data may be transmitted in packets (as described above). The control data may be stored in the payload of such packets according to a common format. As described above, the common format may vary depending on the intended recipient of the data. For example, the control data for a downhole tool to perform formation evaluation using resistivity measurements would be common across different downhole service providers (but would be different from control data for a downhole tool for measuring drill string vibration). The control data may modify specific parameters for collection of data by a sensor, (such as the type of data, the timing of collection, etc.). However, the common format enables the control data to be decoded by the components in the downhole tool, independent of the downhole service provider.

The communications to the downhole tools 314 may be based on a number of different addressing configurations. In some embodiments, each downhole tool has a unique address. Accordingly, the data transmitted downhole may be addressed to a particular downhole tool. The host component within this downhole tool may then control data communications internal to the downhole tool. Specifically, once the data is received in a particular downhole tool, local addresses within the downhole tool may be used to forward the data to a particular component therein. In some embodiments, the different sensors in the downhole tools have a unique address across the bottomhole assembly. Accordingly, a surface component may transmit data directly to a component in a downhole tool. The flow continues at block 604.

At block 604, control data (coded in a common format) is transmitted from the surface to a second downhole tool of a second downhole service provider, through a shared communications bus in a drill pipe according to the common communications protocol. With reference to FIG. 2, a surface component may transmit the data along the communications buses in the different sections of drill pipe 202 and through communications buses of other downhole tools (similar to the communications from downhole to the surface). In particular the different communications buses across the different downhole tools and the drill pipe sections may be used because of the common communications protocol. Surface components may transmit data to any number of components in any number of downhole tools. After receipt, the components in the downhole tools may then process such data. For example, the control data may modify the collection of data, how or when such collected data is transmitted to the surfaced, etc.

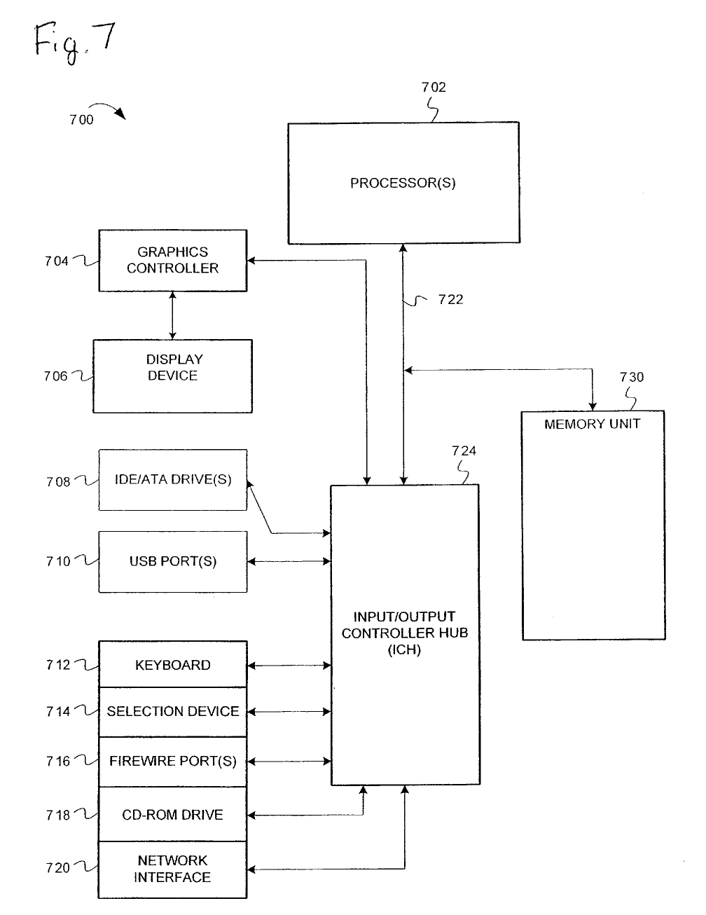

FIG. 7 illustrates a computer that executes software for performing operations related to communications of downhole tools from different downhole service providers, according to some embodiments. The computer 700 may be representative of various components in the drill string 200, the system 300, etc. The various components in the drill string 200, the system 300, etc. may have more or less components than those illustrated by the computer 700 of FIG. 7. For example, if the computer 700 is representative of components in the drill string 200, such components may not include a display device, keyboard, etc.

As illustrated in FIG. 7, the computer 700 comprises processor(s) 702. The computer 700 also includes a memory unit 730, processor bus 722, and Input/Output controller hub (ICH) 724. The processor(s) 702, memory unit 730, and ICH 724 are coupled to the processor bus 722. The processor(s) 702 may comprise any suitable processor architecture. The computer 700 may comprise one, two, three, or more processors, any of which may execute a set of instructions in accordance with embodiments of the invention.

The memory unit 730 may store data and/or instructions, and may comprise any suitable memory, such as a dynamic random access memory (DRAM). The computer 700 also includes IDE drive(s) 708 and/or other suitable storage devices. A graphics controller 704 controls the display of information on a display device 706, according to some embodiments of the invention.

The input/output controller hub (ICH) 724 provides an interface to I/O devices or peripheral components for the computer 700. The ICH 724 may comprise any suitable interface controller to provide for any suitable communication link to the processor(s) 702, memory unit 730 and/or to any suitable device or component in communication with the ICH 724. For one embodiment of the invention, the ICH 724 provides suitable arbitration and buffering for each interface.

For some embodiments of the invention, the ICH 724 provides an interface to one or more suitable integrated drive electronics (IDE) drives 708, such as a hard disk drive (HDD) or compact disc read only memory (CD ROM) drive, or to suitable universal serial bus (USB) devices through one or more USB ports 710. For one embodiment, the ICH 724 also provides an interface to a keyboard 712, a mouse 714, a CD-ROM drive 718, one or more suitable devices through one or more firewire ports 716. For one embodiment of the invention, the ICH 724 also provides a network interface 720 though which the computer 700 can communicate with other computers and/or devices.

In some embodiments, the computer 700 includes machine-readable media that stores a set of instructions (e.g., software) embodying any one, or all, of the methodologies described herein. Furthermore, software may reside, completely or at least partially, within memory unit 730 and/or within the processor(s) 702. The computer 700 may include machine-readable media that store data (such as data collected from the sensors, control information, etc.).

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. An apparatus comprising:
a tubular for downhole operations, the tubular comprising a bottomhole assembly, the bottomhole assembly comprising,
a first downhole tool having a first sensor that is to generate a first data, wherein a first entity is at least one of a controller or an owner of the first downhole tool;
a second downhole tool having a second sensor that is to generate a second data, wherein a second entity is at least one of a controller or an owner of the second downhole tool, wherein the first data and the second data are to be coded in a common format;
a processor to execute instructions to receive and process the first data and the second data.

2. The apparatus of claim 1, wherein the instructions to process comprise instructions to perform a combined analysis based on the first data and the second data.

3. The apparatus of claim 1, wherein the tubular further comprises a drill pipe coupled to the first downhole tool and the second downhole tool, the drill pipe having a communications bus to transmit the first data from the first sensor and the second data from the second sensor to the surface of the Earth.

4. The apparatus of claim 3, wherein the communications bus is controlled by an entity that is different from the first entity and the second entity.

5. The apparatus of claim 3, further comprising a surface computer and a machine-readable medium, wherein the surface computer is to store the first data and the second data in the machine-readable medium.

6. The apparatus of claim 5, wherein the first data on the machine-readable medium is accessible to the first entity but not to the second entity, and wherein the second data on the machine-readable medium is accessible to the second entity but not to the first entity.

7. The apparatus of claim 5, wherein the first data on the machine-readable medium is to be sent to the first entity, and wherein the second data on the machine-readable medium is to be sent to the second entity.

8. The apparatus of claim 5, wherein at least one of the first data and the second data is to be sent to a different entity that is paying for the services of at least one of the first entity and the second entity.

9. The apparatus of claim 8, wherein at least one of the first data and the second data is to be sent to the different entity in real time.

10. The apparatus of claim 8, wherein the processor is to receive a command to modify a drilling parameter from any one of the first entity, the second entity and the different entity, in response to receipt of the first data and the second data.

11. The apparatus of claim 3, wherein a communications component at the surface of the Earth is to transmit data to the first downhole tool and the second downhole tool.

12. The apparatus of claim 3, wherein the first data and the second data are to be transmitted along the communications bus based on a common communications protocol.

13. The apparatus of claim 1, wherein at least one of the first sensor and the second sensor comprise instructions to detect a computer virus.

14. A system comprising:
a tubular for downhole operations, the tubular comprising,
a first downhole tool that is at least one of controlled or owned by a first entity;
a second downhole tool that is at least one of controlled or owned by a second entity; and
a drill pipe, that includes one or more sections, coupled to the first downhole tool and the second downhole tool and having a communications line; and
a communications component at a surface of the Earth, the communications component coupled to the communications line of the drill pipe, wherein data is to be transmitted through the communications line between the communications component and the first downhole tool and the second downhole tool based on a common communications protocol.

15. The system of claim 14, further comprising a different communications component at the surface of the Earth to transmit the data to a location that is remote to the downhole operations.

16. The system of claim 15, wherein the different communications component is to transmit the data to the location wirelessly.

17. The system of claim 15, wherein a processor unit at the location that is remote is to the downhole operations is to analyze the data.

18. The system of claim 17, wherein the processor unit, in response to analysis of the data, to issue a command to modify a drilling parameter.

19. The system of claim 18, wherein the processor unit is to be controlled by a third entity.

20. The system of claim 14, wherein the communications line is controlled by a third entity.

21. The system of claim 14, wherein the first downhole tool comprises a first sensor to collect a first data related to formation evaluation, a borehole property or diagnostic data, wherein the second downhole tool comprises a second sensor to collect a second data related to formation evaluation, a borehole property or diagnostic data, wherein the first data and the second data are at least part of the data to be transmitted through the communications line to the surface.

22. The system of claim 21, further comprising a machine-readable medium at the surface and coupled to the communications component, wherein the machine-readable medium is to store the first data and the second data.

23. The system of claim 20, further comprising a gatekeeper coupled to the machine-readable medium, wherein the gatekeeper is to allow the first entity, but not the second entity, to access the first data on the machine-readable medium, and wherein the gatekeeper is to allow the second entity, but not the first entity, to access the second data on the machine-readable medium.

24. The system of claim 23, wherein the first entity is to perform at least one of borehole correction, standoff correction, thin bed correction, invaded zone correction, photoelectric effect correction and background correction to the first data.

25. The system of claim 14, wherein the tubular further comprises a power source that is to supply power to the first downhole tool and the second downhole tool.

26. The system of claim 14, wherein the first downhole tool comprises a first sensor and a first power source that is to supply power to the first sensor, and wherein the second downhole tool comprises a second sensor and a second power source that is to supply power to the second sensor.

27. The system of claim 14, wherein the first downhole tool comprises a first sensor and a power source, wherein the second downhole tool comprises a second sensor, and wherein the power source is to supply power to the first sensor and the second sensor.

28. The system of claim 14, wherein the common communications protocol is based on an Institute of Electrical and Electronics Engineers 802.3 standard.

29. The system of claim 14, wherein the first downhole tool is coupled to the drill pipe through the second downhole tool, wherein communication between the first downhole tool and the second downhole tool is based on the common communications protocol.

30. The system of claim 29, wherein the second downhole tool comprises a communications bus, wherein communications on the communications bus is based on a communications protocol that is different from the common communications protocol.

31. A method comprising:
transmitting a first data, to the surface of the Earth, from a first sensor in a first downhole tool that is at least one of controlled or owned by a first entity through a shared communications bus that is through a drill pipe, wherein the transmitting of the first data is based on a common communications protocol; and
transmitting a second data, to the surface of the Earth, from a second sensor in a second downhole tool that is at least one of controlled or owned by a second entity through a communications bus within the first downhole tool and through the shared communications bus that is through the drill pipe, wherein the transmitting of the second data through the shared communications bus is based on the communications protocol.

32. The method of claim 31, wherein the shared communications bus is controlled by a third entity that is independent of the first entity and the second entity.

33. The method of claim 32, further comprising performing the following operations at the surface of the Earth:
storing the first data and the second data on a machine-readable medium accessible by the at least two different entities;
plotting logs of the first data and the second data.

34. The method of claim 30, wherein the first data on the machine-readable medium is accessible by the first entity and the third entity but not by the second entity, and wherein the second data on the machine-readable medium is accessible by the second entity and the third entity but not by the first entity.
